(19) United States
(12) Patent Application Publication
(10) Pub. No.: US 2011/0130209 A1
(43) Pub. Date: Jun. 2, 2011

(54) Flexible Coupling Assembly with Embedded Torque Transmitting Elements

(75) Inventor: Ryan LaFevre, Greenville, SC (US)

(73) Assignee: RELIANCE ELECTRIC TECHNOLOGIES, LLC, Greenville, SC (US)

(21) Appl. No.: 12/627,557

(22) Filed: Nov. 30, 2009

(51) Int. Cl. F16D 3/64

(52) U.S. Cl. 464/82

(57) ABSTRACT

A flexible coupling element for connecting two shafts in a coaxial alignment has a resilient member with an inner surface and an outer surface. The resilient member inner surface has a plurality of notches adapted to receive connection members projecting axially from respective ends of the shaft. The resilient member has a plurality of torque-transmitting elements disposed between the notches. The torque-transmitting elements are more rigid than the resilient members, thereby allowing the torque to be transmitted between the two shafts in the event the flexible element fails.

### BACKGROUND

The disclosure relates to a flexible coupling assembly having torque transmitting elements in the flexible element that enable the flexible coupling assembly to operate in the event the flexible element fails.

### BRIEF DESCRIPTION OF THE DRAWINGS

FIG. 1 shows a perspective view of a flexible coupling assembly including a shaft hub and flexible element disposed on the shaft hub;

FIG. 2 shows a perspective view of the flexible element used in connection with the flexible coupling assembly of FIG. 1;

FIG. 3 shows a side view of the flexible element of FIG. 1;

FIG. 4 shows a front view of the flexible element of FIG. 1 (i.e. a view of the flexible element from the right side of FIG. 3);

FIG. 5 shows a partial cross-sectional view of the flexible element taken through lines 5-5 of FIG. 3;

FIG. 6 shows an enlarged cross-sectional view of detail area 6-6 of FIG. 5;

FIG. 7 shows a perspective view of a torque transmitting element disposed within the flexible element of FIG. 2;

FIG. 8 shows a side view of the flexible torque transmitting element of FIG. 7; and

FIG. 9 shows a front view of the torque transmitting element of FIG. 7 (i.e. a view of the torque transmitting element from the right side of FIG. 8).

### DETAILED DESCRIPTION

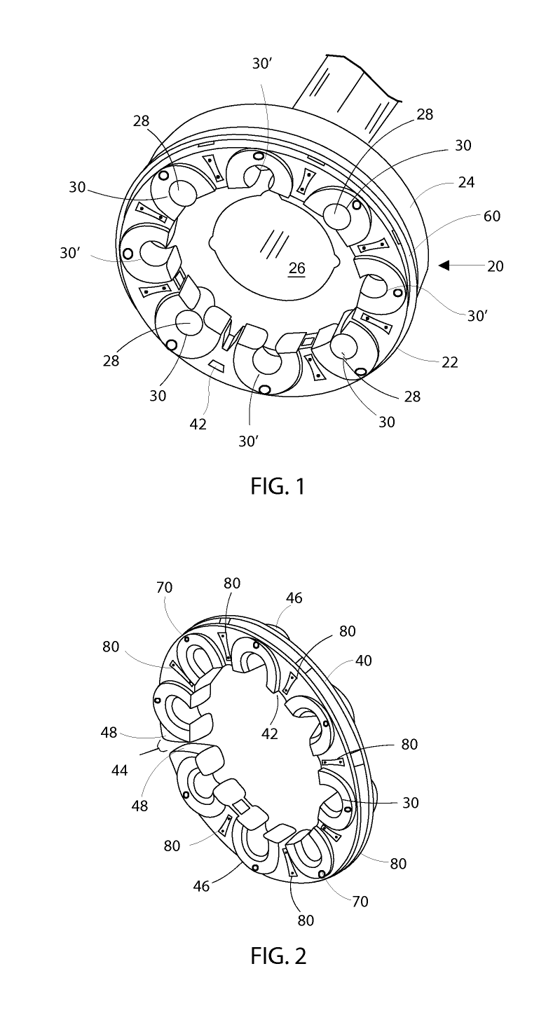

FIG. 1 shows a wrap-style coupling assembly 20 used to connect two shaft ends together in a co-axial alignment, enabling torque to be transferred from one shaft to another while allowing for misalignment of the shafts. A wrap-style flexible coupling assembly facilitates replacement and/or installation of a flexible element of the coupling between two shafts by eliminating the requirement that the hubs or flanges of the shafts be moved axially. In other words, when the flexible element of the coupling needs to be replaced, the hubs or flanges associated with the shafts do not need to be moved, but rather they may remain in place and the flexible element may be “wrapped” around the flanges and secured in place.

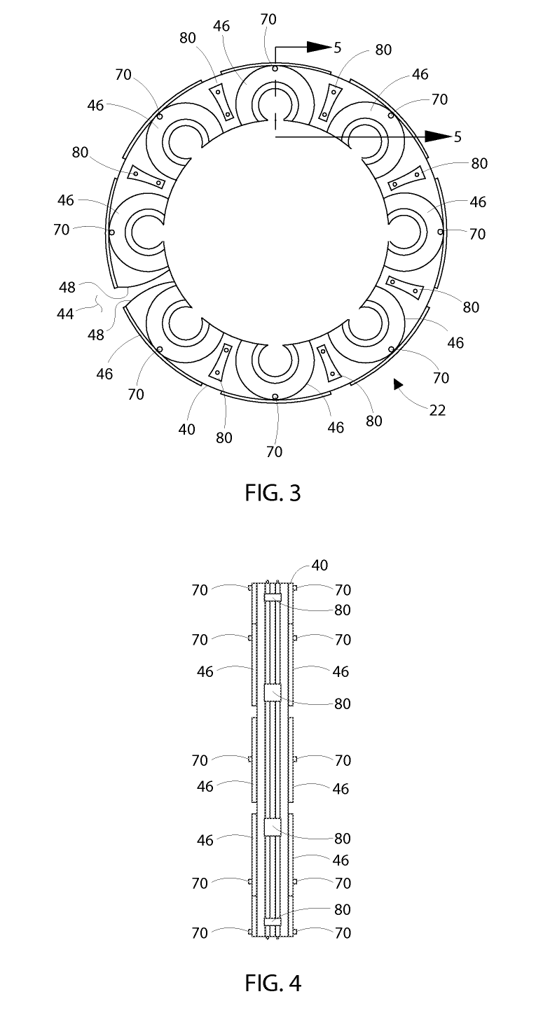

FIG. 1 shows a flexible element 22 “wrapped around” or installed on one shaft hub 24, and the shaft hub is mounted to a shaft end 26. The other shaft hub is not depicted thereby enabling the showing of additional detail of the cooperative relationship of the flexible element and the hub. It should be appreciated that the flexible coupling assembly may be provided as a kit comprising a flexible element, shaft hubs and a band for securing the flexible element around the shaft hubs, for instance, as may be needed for a new installation, or a flexible element such as that shown in FIGS. 2 and 3 may be provided without shaft hubs as a replacement element in an existing installation. The first shaft hub 24 (depicted in FIG. 1) has four connecting members or pins 28 which locate in four of eight notches 30 of the flexible element. It should be appreciated that the second shaft hub (not shown) will have an arrangement similar to the first shaft hub, and its four pins will locate in the remaining four notches 30′ of the flexible element in an overlapping or alternating fashion with the first shaft hub.

FIGS. 2 and 3 provides additional detail of the flexible element 22. The flexible element comprises a resilient member with an outer surface 40 and an inner surface 42 and an end gap 44 extending therebetween. The resilient member notches 30 are formed on the resilient member inner surface 42 and receive the connecting members 28 extending from the shaft hubs (i.e., shaft flanges). Preferably, the notches 28 comprise partially circular holes that receive pins extending from the shaft hubs. By forming the flexible element from a resilient material, the coterminous edge of the notch 28 and resilient member inner surface 42 may be deflected or springably moved to allow the connecting member to be press fit in the notch. It should be appreciated that other shapes may be used depending upon type of the connecting members extending from the shafts. Additionally, it should be appreciated that connecting members may extend directly from the shafts or may extend from flanges connected to the shafts. To provide additional structural integrity for the notches, the resilient member may have reinforced areas or bosses 46 extending around the notches on its side face. The resilient member may take the form of a ring in its free state, and by spreading the end gap 44 apart, the resilient member may be opened at its ends 48 a distance sufficient to allow the resilient member to be wrapped around the connecting members of the shaft hubs, or the shaft, depending upon the configuration of the application. In one such application, the resilient member is made in a free state ring shape from a urethane thermoplastic elastomer. For instance, the resilient member may be injection molded in such a form. A urethane thermoplastic elastomer provided by Bayer Material Science known as Texin™ 390 has proven effective for this purpose. The resilient member may also be formed from a flexible elongated strip of material in its free state with notches on one longitudinal side and a generally flat surface on the opposite longitudinal side, and formed into a ring shape during installation as it is wrapped around the shaft hubs.

As mentioned previously, each of the notches 30 of the resilient members captures a respective connecting member 28 of the shaft hub. Referring to FIG. 1, the connecting members are preferably arranged in an overlapping pattern so that one notch captures the connecting member associated with one shaft and the next adjacent notch captures a connecting member associated with the other shaft hub. Although the flexible element shown in the drawing has eight notches, four of which capture connecting members associated with one shaft, and the adjacent four of which capture connecting members associated with the other shaft, it should be appreciated that the number of notches may be varied in accordance with the application, including the size of the shaft, the shaft hubs and coupling diameter, and torque requirements of the application. Likewise, it is not necessary that each notch of the flexible element receive a pin from a shaft hub. The arrangement of the notches facilitates loading the element in compression maximizing the torque density associated with the coupling.

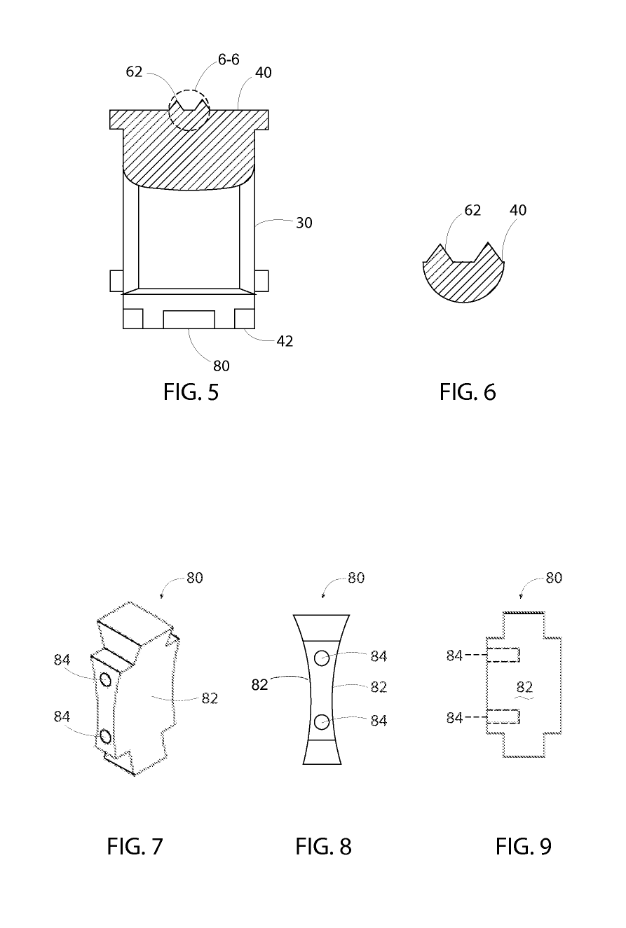

To maintain the flexible element in a fixed position and engaged with the shafts, a metal band 60 (FIG. 1) may be wrapped around the outer surface of the flexible element. To facilitate locating the band around the outer surface of the flexible element, a groove 62 may be provided as shown in FIGS. 5 and 6.

As shown in FIGS. 2, 3, and 4, the flexible element may be provided with small circular tabs 70 on its side face. The tabs 70 enable one to set the spacing of the flanges 24 on the shafts 26, and thus the spacing needed between the flanges to accommodate the flexible element, during installation of the coupling assembly.

The flexible element 22 may also comprise torque transmitting elements 80 disposed between the notches 30. FIGS. 7-9 provide additional detail of the torque-transmitting elements 80. The torque-transmitting elements 80 may be formed from a material which is more rigid than the resilient member. For instance, the torque-transmitting elements may be made from a plastic resin. Valox™ Resin 420 HP provided by GE Plastics has proven effective. Valox™ Resin 420 HP is a polybutylene terephthalate plastic material with filler. Additionally, plastic material #900601-HR-35-WT provided by Adell Plastics, Inc. has also proven to be a satisfactory material. The torque-transmitting elements 80 are disposed in the resilient member, and prevent the connecting members 28 of the shafts from coming into contact with one another in the event of failure of the resilient member. By providing torque transmitting elements between overlapping connecting members of the shaft hubs, the coupling assembly may continue to function without damaging the connecting members of the shaft hubs to the point where the shaft hubs and/or connecting members need to be replaced. Thus, in the event of failure of the resilient member, torque may continue to be transmitted from one shaft to another shaft via the torque-transmitting elements 80. Referring to FIGS. 2 and 5, the torque-transmitting elements 80 may extend from one side face of the flexible element to an opposite side face of the flexible element. A portion of the torque transmitting elements may extend from the outer surface 40 of the resilient member to the inner surface 42 of the resilient member. While the drawings show a torque transmitting element disposed between each notch, it should be appreciated that one or more of the torque transmitting elements may be eliminated. As shown in FIGS. 7 and 8, the torque-transmitting elements 80 may be formed with convex side faces 82 so as to provide a relatively stable bearing surface between the torque transmitting element and the connecting member during contact. The torque transmitting elements may be inserted or press fit in holes formed in the resilient member or the resilient member may be molded around the torque transmitting elements. To facilitate plastic mold injection methods, the torque-transmitting elements may be provided with mounting holes 84 to receive pins in the plastic mold injection tooling, thereby allowing the resilient member to molded around the torque-transmitting elements.

In the installation and operation of the flexible coupling, the two flanges are assembled on the respective shafts and secured thereto. The spacing between the shaft hubs may be set using the circular tabs formed on the flexible element. With the two flanges properly assembled on the shaft and the shafts in proper alignment, the flexible element is then assembled in place on and between the two flanges by spreading apart the ends of the resilient member on either side of the end gap sufficiently to permit the coupling to slip over the shaft and the flanges and then partially close. The notches of the resilient member may receive and capture the connecting members. The notches are sized to releasably engage the connecting members by allowing the resilient member to springably deflect as the flexible element is wrapped and then pushed around the connecting members of the shaft hubs. Once the connecting members are engaged with the notches of the resilient member, a metallic band may be wrapped around the outer surface of the flexible element and secured in place. With the flexible element assembled on the two flanges in the foregoing manner, torque is efficiently transmitted from shaft to shaft and the flexible element effectively accommodates any misalignment of the two shafts without any substantial loss of torque therebetween.

In the event the flexible element needs to be replaced, the flexible element may be removed from the two shaft flanges by first removing the metallic band, and spreading the ends of the resilient member apart at the end gap so as to disengage the connecting members from the notches of the resilient member. A replacement flexible element may thereafter be readily installed in place without the need to displace either one of the two shaft flanges.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalents thereof.

What is claimed is:

1. A flexible element for a coupling connecting two shafts in a coaxial alignment comprising:
a resilient member having an inner surface and an outer surface, the resilient member inner surface having a plurality of notches adapted to receive connection members projecting axially from respective ends of the shafts, the resilient member having a plurality of torque transmitting elements embedded in the resilient member and disposed between the notches, the torque transmitting elements being more rigid than the resilient member.

2. The flexible coupling element of claim 1, wherein the resilient member is ring shaped in its free state.

3. The flexible coupling element of claim 2 wherein torque transmitting elements extend between opposite side faces of the resilient member.

4. The flexible coupling element of claim 1, wherein the resilient member inner surface notches are adapted to receive shaft connection members from the respective shafts in an alternating fashion.

5. The flexible coupling element of claim 1, wherein the outer surface has a groove to receive a fastening band for holding the resilient member in engaging contact with the shaft connection members.

6. The flexible coupling element of claim 1, wherein side faces of the resilient member have tabs for setting a spacing between the shaft ends.

7. The flexible coupling element of claim 1, wherein the notches are generally circular in shape for receiving pin shaped shaft connection members.

8. The flexible coupling element of claim 1, wherein sides of the torque transmitting elements adjacent the notches have a convex shape.

9. A flexible coupling assembly for connecting two shafts in a coaxial alignment comprising:
a hub adapted to be mounted on an end of each the shafts, each hub having connection members projecting therefrom;
a flexible element mounted to each shaft hub, the flexible element comprising a resilient member having an inner surface and an outer surface, the resilient member inner surface having notches adapted to receive the hub connection members of each hub, the resilient member having a plurality of torque transmitting elements embedded therein, each of the torque transmitting elements being disposed between each of the notches, the torque transmitting elements being formed from a material more rigid than the resilient member.

10. The flexible coupling assembly of claim 9, wherein the resilient member is ring shaped in its free state.

11. The flexible coupling assembly of claim 10, wherein torque transmitting elements extend between opposite side faces of the resilient member.

12. The flexible coupling assembly of claim 9, wherein the resilient member inner surface notches receive shaft connection members from the respective shaft hubs in an alternating fashion.

13. The flexible coupling assembly of claim 9, wherein the resilient member outer surface has a groove to receive a fastening band for holding the resilient member in engaging contact with the shaft connection members.

14. The flexible coupling assembly of claim 9, wherein side faces of the resilient member have tabs for setting a spacing between the shaft ends.

15. The flexible coupling assembly of claim 9, wherein the notches are generally circular in shape for receiving pin shaped shaft connection members.

16. The flexible coupling assembly of claim 9, wherein sides of the torque transmitting elements adjacent the notches have a convex shape.

17. A flexible coupling assembly for connecting two shafts in a coaxial alignment comprising:
a hub adapted to be mounted on an end of each of the shafts, each hub having connection members projecting therefrom;
a ring shaped flexible element adapted to extend between and operatively mount to each shaft hub, the flexible element having a plurality of torque transmitting elements to be disposed between the hub connection members in a spaced apart relationship when the flexible element is assembled with the hubs, the flexible element comprising a resilient member molded around the torque transmitting elements, the resilient member formed with notches on its inner surface adapted to receive the hub connection members of each hub in an overlapping fashion, the torque transmitting elements being more rigid than the resilient member.

18. The flexible coupling assembly of claim 17, wherein the notches are generally circular in shape for receiving pin shaped shaft connection members.

19. The flexible coupling assembly of claim 17, wherein sides of the torque transmitting elements adjacent the notches have a convex shape.

20. The flexible coupling assembly of claim 17, wherein torque transmitting elements extend between opposite side faces of the resilient member.
